(19) United States
(12) Patent Application Publication
(10) Pub. No.: US 2014/0053060 A1
(43) Pub. Date: Feb. 20, 2014

(54) WEBSITE DEVELOPMENT TOOL

(71) Applicant: Launchbase, LLC, Redmond, WA (US)

(72) Inventors: Gilbert Walker, Bellevue, WA (US); Leif Alexander, Gig Harbor, WA (US); Matt Franklin, Bellevue, WA (US)

(73) Assignee: Launchbase, LLC, Redmond, WA (US)

(21) Appl. No.: 13/969,219

(22) Filed: Aug. 16, 2013

Related U.S. Application Data
(60) Provisional application No. 61/684,653, filed on Aug. 17, 2012.

(51) Int. Cl. G06F 17/22

(52) U.S. Cl. CPC G06F 17/2247
USPC 715/234

(57) ABSTRACT

A website is opened in a website development tool, and pages of the website are served with a web server. The web server accepts user input arranged to direct interactive execution the web page being served. A design editor is opened while the web pages continue to be served. The design editor presents a digital graph paper image configured to display one or more separately identifiable groups of one or more grid blocks of the digital graph paper image. Each of the separately identifiable groups represents a displayable object included in at least one web page. User input into the design editor is arranged to select a sector of grid blocks and modify a set of characteristics associated with the sector. A build process and a deployment process are executed in real time and the modified web page is served in real time.

### BACKGROUND

1. Technical Field

The present disclosure generally relates to improving the efficiency of a software professional to create and manage a website and more particularly, but not exclusively, relates to tools and techniques to gather images, text, audio, video, and other computer deliverable content as a database and program code package that is interactively presentable over a network in the form of a commercially desirable website.

2. Description of the Related Art

A website is generally recognized as a single entity. A website is formed from group of related web pages that are accessible by a user communicating with a computer over a network (e.g., the Internet). A computing program running on a user's computer is configured as a web browser, and a computer program running on a computing server is configured as a web server.

The user's computer web browser interactively communicates with the computing server's web server. At the direction of the user, the web server loads (i.e., “serves”) selected web pages of the website. The web pages may contain images, text, audio, video, executable code, network links, and other computing objects. When a web page is loaded, data is communicated between the user computer, the web server, and other computing servers that are part of the network. The data is communicated in one, two, or many different directions.

A website generally has a “home” page. The home page of a website is the first page presented to a computer user when the user directs a web browser to the website. A typical home page includes images, text, and network links to other home pages. The home page can also include audio, executable functions, and many other computing objects. From the home page, the user is generally able to navigate to other web pages of the website.

In some cases, software professionals create websites using individual software tools to create images and text having the desired characteristics. For example, ADOBE PHOTOSHOP can be used to prepare images that will be graphically displayed on a web page. Various text editors, for example ADOBE DREAMWEAVER, can be used to write executable web page program code (e.g., hyper-text markup language (HTML), extensible markup language (XML), JavaScript, and the like) that will determine how the website functions. Using individual software tools to create websites is a complex task that is typically performed only by experienced software professionals.

In other cases, software professionals create websites using an interactive development environment (IDE). The IDE gives a software professional an opportunity to gather files of many different types (e.g., images, text, audio, video, etc.) and inter-relate the files in any desirable way as a group of web pages. Additionally, the software professional can author program code to execute functions at the direction of a user of the website. The executed functions can navigate to other web pages of the website, navigate to other websites, serve multimedia content, perform algorithms, and nearly every other conceivable computing function.

The IDE permits the software professional to design the website in any way. The software professional can design the web pages of the website using an IDE more quickly than if individual tools are used. For example, the software professional can include colored backgrounds, images, text of different fonts and sizes, products for sale, links to product pages, and the many other objects by “dragging and dropping” images into templates, importing images and other files from known locations, including pre-written self-contained software functions. The objects on a web page can be easily sized and positioned for presentation to a user according to any “look and feel” that the software professional desires. A less-experienced software professional using an IDE can often design and build a website more quickly and efficiently than a more-experienced software professional using individual software tools.

### BRIEF SUMMARY

A new and efficient tool set is disclosed to improve the efficiency of software professionals during development of websites. A software professional uses a browser to navigate to a certain website. The website presents in website development environment (WDE) interface. Through the WDE interface, the software professional can create a brand-new website or modify an existing website. When a new website is being created, a basic, empty new website shell is formed. The subject window (i.e., the new website or the website to be modified) is opened in a browser window. Concurrently, a grid-based design editor is opened in a floating window. The floating window and the browser window serving the subject website are both visible. The floating window serving the design editor can be moved anywhere above or alongside the browser window since the two windows are unattached.

The grid-based design editor appears to the software professional as a sheet of digital graph paper. That is, a multi-column array of grid blocks. From within the grid-based design editor, the software professional can horizontally select groups of grid blocks. The selected sector of grid blocks can horizontally span one or more grid blocks up to the number of columns in the sheet of digital graph paper.

When the grid blocks are selected, the selected sector is highlighted in real time on the subject webpage. By highlighting the subject webpage, the software professional can see in real time the area of the webpage that is being developed.

The software professional can modify characteristics of the selected groups of grid blocks. The characteristics that can be modified include background colors, fonts, font sizes, text, images, links, and nearly any other characteristic that can be programmed into a website. The software professional modifies the characteristics, and in real time, the webpage is modified. In this way, the software professional can immediately see the results of the actions taken. By forming the website design editor as an array of grid blocks, a website can quickly and efficiently be created and modified.

In one embodiment, a website development method includes opening a website with a web development tool. The website has at least one web page, and each web page of the website includes a set of computer readable instructions configured to create one or more displayable objects on the webpage. The web pages of the website are served with a web server, which includes actively processing a first one or more of the set of computer readable instructions of a web page being served. The method includes the act of accepting website user input into the web server, the website user input arranged to direct interactive execution of a second one or more of the set of computer readable instructions of the web page being served. The method also includes the act of opening a design editor while continuing to serve web pages of the website. The design editor is configured to present a digital graph paper image, the digital graph paper image configured to display one or more separately identifiable groups of one or more grid blocks of the digital graph paper image, each of the one or more separately identifiable groups being representative of a displayable object included in a presently served web page of the website. The design editor is also configured to accept first design editor user input, the first design editor user input arranged to select a sector of one or more grid blocks of the digital graph paper and accept second design editor user input, the second design editor user input arranged to modify a set of characteristics associated with the sector. The design editor is further configured to execute a build process in real time, the build process configured to generate a second set of computer readable instructions and execute a deployment process in real time, the deployment process configured to integrate the second set of computer readable instructions into the set of computer readable instructions, wherein the set of computer readable instructions having the integrated second set of computer readable instructions is served by the web server in real time.

In another embodiment, a non-transitory computer readable storage medium has stored contents that configure a computing system to perform a method. The method includes the acts of opening a web development tool website with a browser, opening a managed website with the web development tool, and serving web pages of the managed website with a web server embedded in the web development tool. The method also includes the acts of accepting first user input into the web server, the first user input arranged to direct interactive execution of a web page design editor, opening the design editor while continuing to serve web pages of the managed website, and associating a first web page of the managed website with the design editor. Further, the method includes the additional acts of presenting a digital graph paper image with the design editor, the digital graph paper image configured to display one or more separately identifiable groups of one or more grid blocks of the digital graph paper image, each of the one or more separately identifiable groups being representative of an object included in the associated first web page, accepting second first user input, the second user input arranged to select a sector of one or more grid blocks of the digital graph paper, and accepting third user input, the third user input arranged to modify a set of characteristics associated with the sector. Further still, the method includes the acts of executing a build process in real time, the build process configured to update the first web page according to the third user input, and executing a deployment process in real time, the deployment process configured to integrate the updated first web page with the managed website.

In yet one more embodiment, a development computing server includes a central processing unit (CPU) and a memory. The memory has program instructions thereon arranged to be executed by the CPU. The program instructions configured to open a web development tool website with a browser, open a managed website with the web development tool, serve web pages of the managed website with a web server embedded in the web development tool, accept first user input into the web server, the first user input arranged to direct interactive execution of a web page design editor, open the web page design editor while continuing to serve web pages of the managed website, associate a first web page of the managed website with the web page design editor, present a digital graph paper image with the web page design editor, the digital graph paper image configured to display one or more separately identifiable groups of one or more grid blocks of the digital graph paper image, each of the one or more separately identifiable groups being representative of an object included in the associated first web page, accept second first user input, the second user input arranged to select a sector of one or more grid blocks of the digital graph paper, accept third user input, the third user input arranged to modify a set of characteristics associated with the sector, execute a build process in real time, the build process configured to update the first web page according to the third user input, execute a deployment process in real time, the deployment process configured to integrate the updated first web page with the managed website, and accept fourth user input, the fourth user input arranged to interact with the modified set of characteristics on the updated first web page, the updated first web page having been served by the web server.

In addition to the design editor, and website development tool has many other optional features that are accessible through the website development environment (WDE) interface. For example, one feature allows the design of a website to be imported or exported from the website development tool in an efficient, streamlined manner. In this way, the desirable features of a website can easily be reproduced in a different website. Another feature of many websites is a set of forms that are filled and to add particular detail to data structures of the website. In this new feature, as web pages are modified or constructed, forms can be filled in using a series of cascaded light boxes, which makes it easier for a software professional to keep track of their progress in the modification. When different features of the development and modification are navigated, a growing list of breadcrumbs are formed, which allows the software professional to see how deeply they are navigated in that particular task. The breadcrumbs also include drop-down lists that include available functions added that particular level of navigation. Another feature of the website development tool includes error dialog boxes that display very specific error information. Other features are also optionally integrated. For example, customizable columns can be included on the products pages of retail websites, content filtering can be performed on a backend server, the management of images that are used during website development are streamlined, and new structures are formed for managing categories. Websites created with the website development tool described herein include another new feature found in other websites. In particular, a website can be created that manages content for a blog, and also includes all of the web pages and functionality of an e-commerce store.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn are not intended to convey any information regarding the actual shape of the particular elements and have been solely selected for ease of recognition in the drawings. One or more embodiments are described hereinafter with reference to the accompanying drawings in which:

FIG. 1 illustrates an embodiment of an Internet website development environment,

FIG. 2 illustrates portions of a non-limiting embodiment of a server such as the computing server of FIG. 1,

FIG. 3 illustrates an embodiment of a WDE interface,

FIG. 4 illustrates an embodiment of a WDE interface,

FIG. 5 illustrates an embodiment of a WDE interface,

FIG. 6 illustrates an exemplary certain web page of a development website and a floating window that contains an interface to a web page design editor,

FIG. 7 illustrates a portion of a floating window that contains a digital graph paper image and an associated web page is shown in a separate window,

FIG. 8 is a block diagram illustrating a creation or modification process of a web page of a website,

FIG. 9 illustrates yet another embodiment of a WDE interface, and

FIGS. 10a-c illustrate different aspects of a “Store” page of a website.

### DETAILED DESCRIPTION

The use of conventional tools and methodologies to develop websites, which includes using both individual software development tools as well as using integrated development environments (IDE), has led to the discovery of a significant drawback with the conventional approach. Conventional website development has heretofore been an iterative and inefficient process. Each website is developed individually; piece-by-piece, and one small piece at a time. Even where templates are utilized to take advantage of previously written program code, the conventional website development process inefficiently demands that a software professional repeat rudimentary tasks over and over again.

For example, in a first step of website development, a software professional using conventional tools will design a small aspect of the website. The small aspect may include designing typical website features such as image selection and placement, providing certain text on a web page with chosen characteristics (e.g., font, color, size, etc.), or writing a program function that will execute upon user input. In a second step, the website's program code will be compiled, linked, and otherwise “built” into an executable website image. Third, the executable website image will be deployed on a web server, and finally, the software professional will test the image by accessing the deployed website image via a web browser. The many steps of the iterative process take time and reduce the efficiency of the software professional. Detrimentally, the process steps are repeated both when the website is first designed and then endlessly, whenever the website is changed. For an active website that frequently changes content (e.g., a storefront, a news gathering service), the time inefficiency is an even larger problem.

The problem of a software professional's inefficiency when developing and maintaining a website has been solved with an inventive website development environment (WDE). The WDE lets software professionals design websites “live” in a theme editor, and every aspect of the website design is available in real time. By integrating certain features in the WDE as floating windows, a software professional can dynamically add and change content in a website, and the added and changed content can be concurrently tested.

In the course of creating the WDE, the inventors solved many other problems and improved many other features associated with conventional website development. For example, as described in detail herein, the WDE provides additional features as identified in Table 1.

TABLE 1
Features of WDE

| | |
|---|---|
| 1. | Live site development in the theme editor wherein |
| | chosen aspects of the site are live; also the floating |
| | window allows dynamic content addition |
| 2. | Cascaded light boxes for forms |
| 3. | Bread-crumbs & drop-down lists hybrid |
| 4. | Fading error dialog boxes with specific error |
| | information |
| 5. | Trace feature |
| 6. | Customizable column(s) on products page |
| 7. | Content filter on back-end |
| 8. | Streamlined image management for site |
| | development |
| 9. | Category structures |
| 10. | Managing content for a blog, web pages, and |
| | ecommerce store all in a single site |
| 11. | Design editor |
| 12. | Fade away dialog boxes |
| 13. | Coordination of customer data across websites |
| 14. | Web-based logo generator |

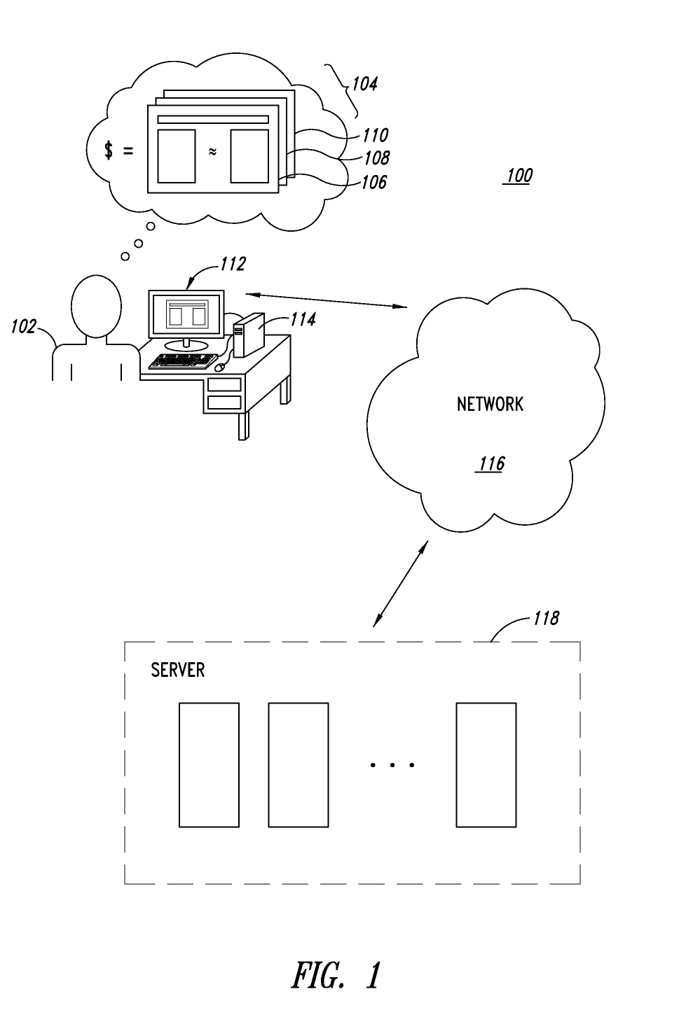

FIG. 1 illustrates an embodiment of an Internet website development environment (WDE) 100.

A user (e.g., software professional) 102 is envisioning a website 104 having multiple web pages 106, 108, 110. Three web pages are shown, including a home page 106; however, any number of web pages could be formed. The website 104 in FIG. 1 is a commercial website in this embodiment, but a non-commercial website could also be developed.

In the embodiment, software professional 102 is developing the website 104 using a website development environment (WDE) interface 112. The WDE interface 112 is configured for operation on a computing device 114. The computing device 114 may be any type of computing device configured to host an embodiment of the WDE interface 112. For example, the computing device 114 may be a personal computer, a laptop computer, a thin client, a tablet device, or the like. Typically, the computing device 114 is configured with input and output (I/O) interfaces for cooperative operations with a variety of I/O devices such as keyboards, mice, touch pads, trackballs, microphones, cameras, motion recognition devices, speakers, presentation devices (e.g., displays), and the like.

The computing device 114 may be coupled through a network 116 to a computing server 118. The network 116 may be a wide area network (WAN) such as the Internet, a local area network (LAN), a personal area network (PAN), a peer-to-peer network, or some other type of network. In other cases, the computing device 114 may operate with features of a computing server, and in such cases, the WDE 100 may be contained in a single computing device such as the computing device 114. For simplicity, embodiments will be described herein in the context of computing server 118, but it is understood that such embodiments could also be carried out within a single computing device 114.

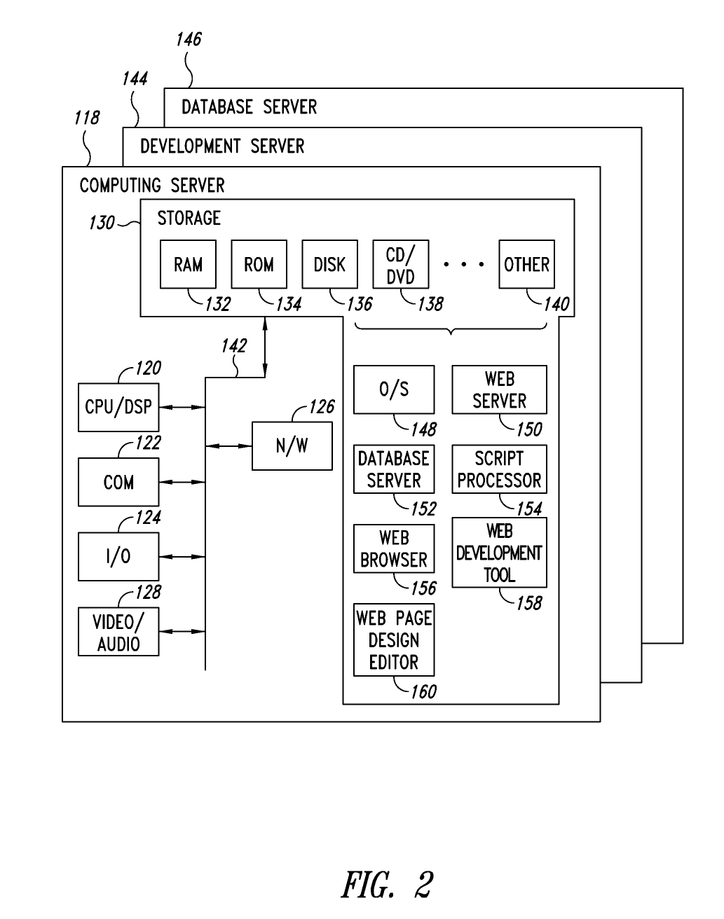

FIG. 2 illustrates portions of a non-limiting embodiment of a server such as the computing server 118 of FIG. 1. Server 118 is a computing server that includes operative hardware found in a conventional computing server apparatus such as one or more central processing units (CPU's) or digital signal processors (DSP's) 120, communication port modules 122, serial and parallel input/output (I/O) modules compliant with various standards and protocols 124, wired and/or wireless networking modules (e.g., a communications transceiver) 126, multimedia input and output modules 128, and the like.

As known by one skilled in the art, the computing server 118 has one or more memories 130, each memory 130 comprises any combination of transitory and non-transitory volatile and non-volatile computer readable media for reading and writing. Volatile computer readable media includes, for example, random access memory (RAM) 132. Non-volatile computer readable media includes, for example, read only memory (ROM) 134, magnetic media such as a hard-disk 136, an optical disk drive 138, and other memory devices 140 such as a floppy diskette, a flash memory device, and/or the like. In some cases, a particular memory is separated virtually or physically into separate areas, such as a first memory, a second memory, a third memory, etc. In these cases, it is understood that the different divisions of memory may be in different devices or embodied in a single memory.

The different modules of computing server 118 are coupled together with one or more buses 142. The buses may transport power, addresses, data, and the like between the different modules of the server 118.

Server 118 further includes operative software found in a conventional computing server such as an operating system, software drivers to direct operations through the I/O circuitry, networking circuitry, and other peripheral component circuitry. In addition, server 118 includes operative application software such as network software for communicating with other computing devices, database software for building and maintaining databases, and task management software for distributing the communication and/or operational workload amongst various CPU's. In some cases, server 118 is a single hardware machine having the hardware and software listed herein, and in other cases, server 118 is a networked collection of hardware and software machines working together in a server farm to execute the functions of the WDE 100. Some conventional hardware and software of server 118 is not shown in other figures for simplicity.

FIG. 2 further illustrates a second server 144 and a third server 146. In FIG. 2, second server 144 is a development computing server, and third server 146 is a database computing server. The servers 144, 146 may include some or all of the modules illustrated and described with respect to computing server 118.

In some cases, computing server 118 is a production computing server. The production computing server 118 is deployed in a real world environment. For example, a user unassociated with the website development can access the website through a web browser communicating over the Internet. The production web server 118 can read and write data from the database server 146 as directed by the program code of the web site and the operations directed by the user. Cooperatively, the development computing server 144 may include some, most, or all of the website program code that is concurrently deployed on the production computing server 118. By mirroring the website program code, physically or virtually on a second computing server, a software professional can add, delete, and otherwise manage the program features or data that embody the website.

FIG. 2 further illustrates software components loaded into the memory 130 of server 120 to form the WDE 100. In some embodiments, the

WDE 100 is stored as one or more files in memory 130. In some aspects, the memory 130 is a non-transitory computer readable media (CRM) configured to store computing instructions executable by a CPU 120. Each file may include one or more computer programs or may be part of a larger computer program. Alternatively or in addition, each file may include data or other computational support material for the WDE 100. The WDE 100 typically executes a set of instructions stored on computer readable media.

Several program modules are stored within one or more of the memory structures of memory 130. The program modules present executable instructions to the CPU 120 to carry out the features of the computing server 118.

Memory 130 may store an operating system 148. The operating system typically provides program and device management services for the computing server 118. Examples of operating systems include any one or more of various versions of LINUX, MICROSOFT WINDOWS, UNIX, and others.

Memory 130 may store web page management and administration tools. For example, memory 130 may optionally store one or more web server 150 modules, database server interface modules 152, script processor 154 modules, and web browser 156 modules. Examples of web server 150 modules include APACHE, MICROSOFT INTERNET INFORMATION SERVICES (IIS), NGINX, and GOOGLE WEB SERVER (GWS). Web servers typically deliver web pages to client devices. Often, the requests are made using Hypertext Transfer Protocol (HTTP), and the web pages are delivered as Hypertext Markup Language (HTML) documents along with any additional content that is called out by the document (e.g., images, style sheets, scripts, functions, and the like).

Examples of database servers interface modules 152 include ORACLE/SUN MICROSYSTEM MYSQL, MICROSOFT SQL SERVER, and APACHE DERBY. A database server interface module typically implements a structured query language (SQL) that performs input and output functions on a relational database. In some cases, a database server interface module 152 implements a data storage repository (e.g., a relational database) in the same hardware that implements the database server (e.g., database server 146), and in other cases, the repository is distributed between several different machines. In some cases, the data repository is implemented in a database server 146 and the database server interface module 152 is implemented in a computing server 118 or development server 144.

A script processor 154 is a computing module that interprets and executes instructions of a scripting language. PHP is one example of a scripting language. MICROSOFT ACTIVE SERVER PAGES (ASP) is another example. In some cases, the scripting language is embedded into the HTML source code of a web page, and interpreted by the script processor module.

Web browser 156 examples include MICROSOFT INTERNET EXPLORER, GOOGLE CHROME, MOZILLA FIREFOX, and APPLE SAFARI.

In some embodiments, the website development environment (WDE) 100 of FIG. 1 may be implemented in the computing server 118 of FIG. 2. In such an embodiment, a web development tool 158 module and a cooperative web page design editor 160 are included to carry out the website development and management functionality of a WDE 100. In particular, the web development tool 158 and web page design editor 160 are configured to implement or otherwise facilitate the features called out in Table 1.

A software professional 102 can access a WDE 100 by starting a web browser 156 installed on a computing device (e.g., computing device 114). The web browser will pass communications over a network (e.g., the Internet) to a website development tool 158 installed on a computing device (e.g., development computing server 144). The navigation to the website development tool 158 can be via a uniform resource locator (URL).

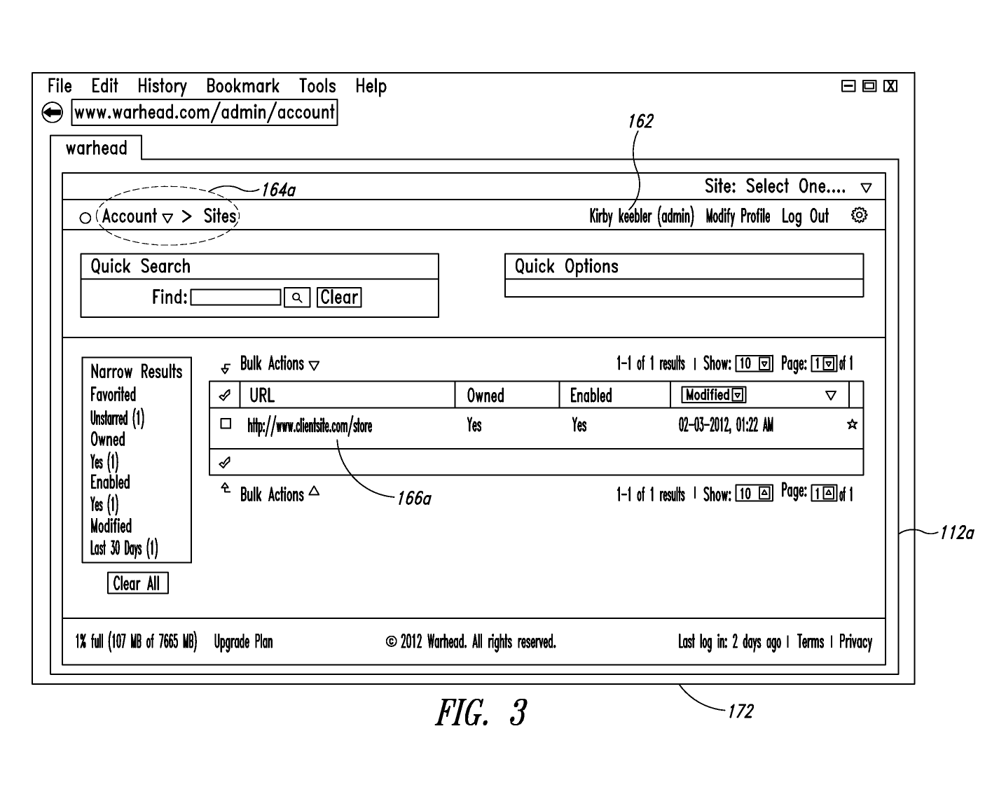

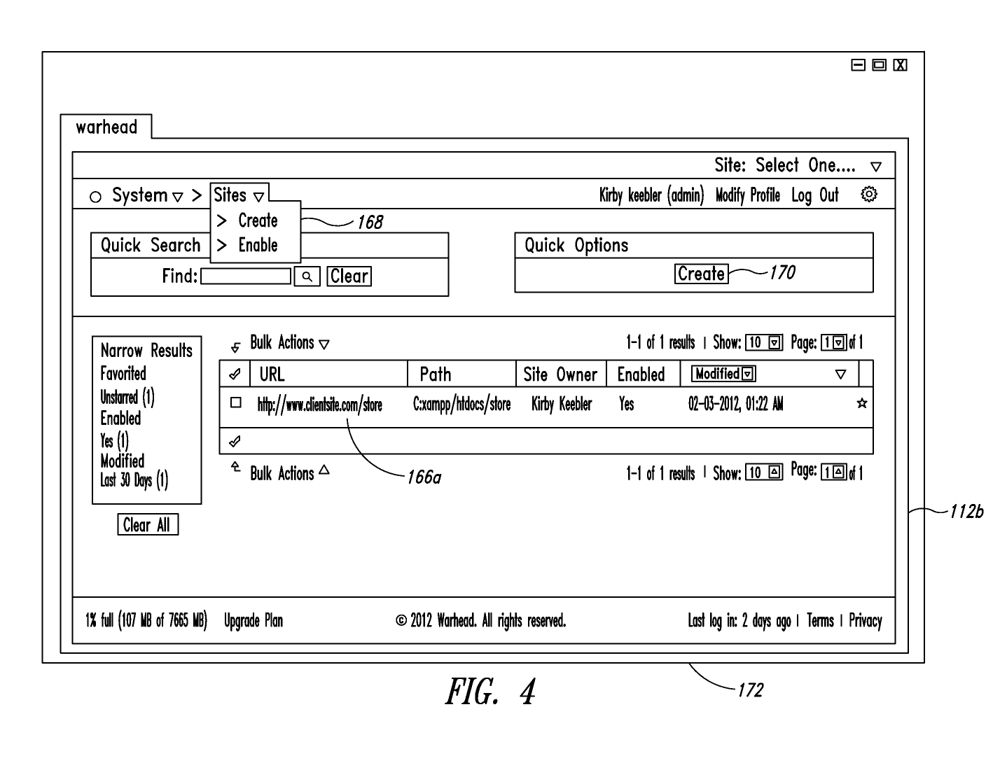

FIG. 3 illustrates an embodiment of a WDE interface 112a. The interface 112a of FIG. 3 illustrates an interface that may be presented within a browser window 172, which is presented after the software professional 102 logs in to the web development tool 158. In the embodiment, the identity credentials of software professional 102 have been sufficiently verified by a username/password combination, previously written cookies, biometric data, hardware identification values unique within the network, or by some other mechanism.

The WDE interface 112a of FIG. 3 illustrates a known relationship with the software professional 102. The identity 162 of the software professional is called out on the WDE interface 112a, and a horizontally presented breadcrumb-with-drop-down-list feature 164a is also called out. The horizontal breadcrumbs illustrate to a user of the WDE interface 112a a nested path of navigation into the web development tool 158. In some cases, the breadcrumbs are implemented ways cookies to track a user's location within the site. In other cases, the breadcrumbs are implemented using indexes in a stack or an array. In still other cases, the breadcrumbs are implemented in other ways.

Drop down lists from each breadcrumb permit the software professional to take targeted action relative to the feature identified by the breadcrumb. The presentation of a navigation feature using horizontally presented breadcrumbs with drop down list 164a provides advantages of a clean, clutter-free interface with intuitively placed, relevant functionality. The breadcrumbs-with-drop-down-list feature provides content on demand. That is, options and actions that are not immediately relevant to the webpage being served are removed or otherwise hidden. In some cases, the determination of which drop-down features are removed is based on the functions that are available to be performed. In other cases, the determination of which drop-down features are removed is a configurable feature. Administrators of the tools can selectively choose to hide features or otherwise make them unavailable to users based on the user's identity and privileges, the dynamic content being served on the webpage, the time of day, the volume of traffic through the website, and for other reasons.

In the WDE interface 112a, the identity 162 of the software professional 102 further linked to a known website 166a. In various embodiments, the WDE interface 112a may indicate particular data about the software professional 102, the known website 166a, past or current navigation, and other information. The user may be linked with the ownership status of the website 166a or another association with the website 166a (e.g., manager, user, data entry provider, administrator, etc.). Once a user is identified with sufficient certainty, the user can manage all of the websites for which they have privileges. That is, a master account can be used to access, modify, create, delete, or take other actions for several websites. Additionally each website can have a tiered access of custom permissions to the entire website or to individual pages of the website.

An additional piece of information on the interface 112a may be an indicator to inform the software professional 102 whether or not the website 166a is “Enabled” for access via the Internet. In such cases, if the website is enabled, the web pages of the website 166a may be present on a production computing server 118. Any user may access the Internet, navigate to the website 166a via a URL, and interact with the website 166a using a browser.

The software professional 102 in some embodiments may manage website 166a using the web development tool 158. When the software professional 102 manages website 166a, a copy of some or all of the web pages of website 166a are communicated from the production server 118 to the development server 144. In some cases, web pages are copied from a memory of a production server 118 to a memory of a development server 144 as the pages are needed, and in other cases, one or more pages are copied before they are needed.

The software professional 102 in some embodiments may create a brand new website 166b.

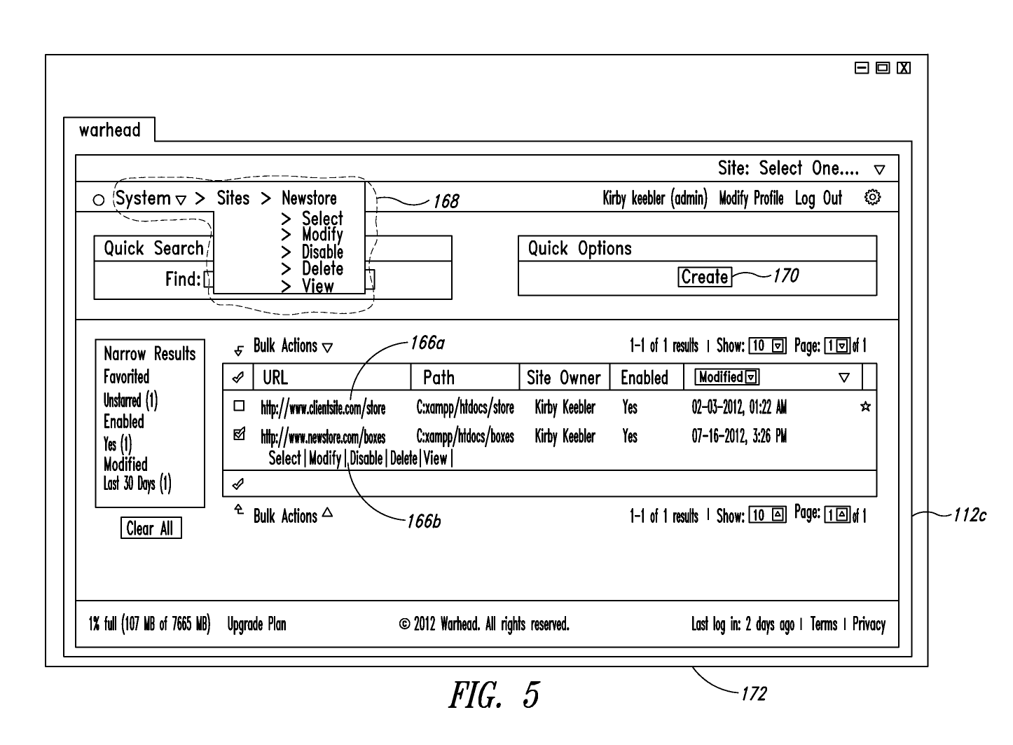

FIG. 4 illustrates an embodiment of a WDE interface 112b. The interface 112b of FIG. 4 illustrates an interface that may be presented within a browser window 172. Also illustrated in the interface 112b are breadcrumb drop down list 168 and a quick action button 170. In the interface 112b, both the breadcrumb drop down list 168 and a quick action button 170 link to the same function of the web development tool 158, however other configurations could also be formed. In the embodiment of FIG. 4, the interface 112b is very uncluttered, and the options available to the software professional 102 are intuitive, related to the tasks available, and easy to understand for even an entry-level software professional 102.

When the software professional 102 actuates a “create” function using, for example, the breadcrumb drop down list 168 or the quick action button 170 of interface 112b, the web development tool will create a new website 166b for the software professional 102. In some cases, the new website 166b is automatically created by the web development tool 158 generating an initial set of computer readable instructions configured to create a home page. For example, the created website 166b may be only a basic website including only a home page. The basic website is generally simple and uncomplicated. The site may include nothing more than a header block having a simple “under construction” message that is displayed in a browser when the web page is loaded. In other cases, the newly created website 166b may be formed by copying one or more files from a first memory location to a second memory location. In such cases, the created website 166b can be either a basic website or a more complicated website. In fact, by utilizing several different file sets as templates, a created website can begin with any type of website from a basic website to a very full-functioned website.

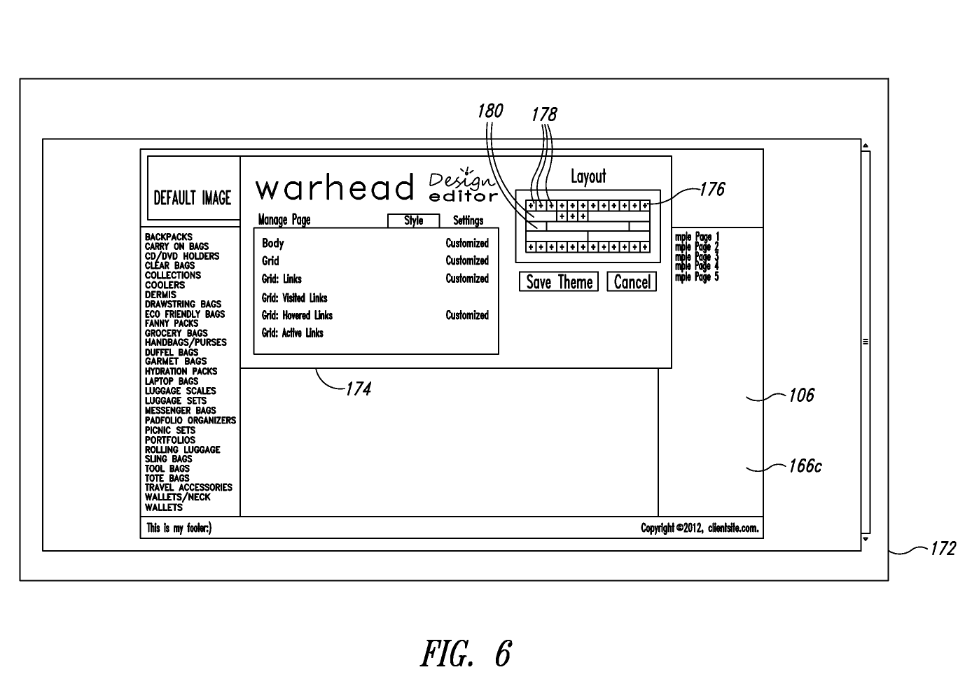

FIG. 5 illustrates an embodiment of a WDE interface 112c. The interface 112c of FIG. 5 illustrates an interface that may be presented within a browser window 172. Also illustrated in the interface 112c are breadcrumb drop down list 168, but additional navigation features are illustrated in the drop down list 168, which correspond to features of the exemplary new website 166b (i.e., “http://www.newstore.com/boxes”). Illustrated in FIG. 5 are selectable features for website 166b (i.e., Select, Modify, Disable, Delete, View). Other features could also be integrated in website 166b, and the same or different features could also correspond to website 166a.

When a website is created, particular actions can be performed by the software professional 102 using the web development tool 158. For example, web pages can be added, deleted, or modified. Content within web pages can be added, deleted, or modified.

Web pages of a website can be viewed in a browser window in a process that is started by the software professional 102 in the web development tool 158. In some cases, a new instance of a web browser 156 is opened, and in other cases, a new tabbed window is opened in the already executing web browser 156. The web development tool 158 opens the website and a web server 150 processes the computer readable instructions of each web page of the website that is served to the web browser 156. The set of computer readable instructions are configured to create objects on the web page when the web page is viewed in the web browser 156. The web page objects include both displayable objects (e.g., text boxes, tables, images, and the like) and un-displayable objects (e.g., links, background functions, and the like).

As the website web pages are served to the web browser 156, user input can be passed into the web browser and accepted. The user input is generally performed by a user of the website to interact with the features of the website. For example, the user input may be arranged to direct interactive execution of a set of computer readable instructions of the web page being served. The user input can direct the web server 150 to navigate to a different web page (e.g., via a hyperlink), perform a function (e.g., play a video clip), or enter keyboard input (e.g., into a text box).

In some cases, the software professional 102 has a desire to add, delete, or modify content on a website. In such cases, the software professional will direct the web development tool 158 to execute a web page design editor 160 module (FIG. 2). The web page that will have content added, deleted, or modified (or an ID associated with the web page) is passed to the design editor 160. Subsequently, the web page design editor 160 is opened and concurrently, the web server will continue to serve web pages of the website, including the web page that is associated with the web page design editor 160. That is, in some embodiments, even as a software professional is manipulating the content of a web page in the web page design editor 160, the web server will continue to serve the manipulated web page to the web browser 156.

FIG. 6 illustrates an exemplary web page of a development website 166c and a floating window 174 that contains an interface to a web page design editor 160 (FIG. 2). The exemplary web page of FIG. 6 may be the home page 106 of FIG. 1, or it may be some other web page. The web page 106 of the development website 166c is presented in the browser window 172. The floating window 174 is a different window that is viewable and movable above, overlapping, or outside of the browser window 172. The floating window 174 can be moved off of the browser window 172 in some cases.

In some embodiments, the web browser 156 and the web page design editor 160 operate on shared data. In other cases, the web browser 156 and the web page design editor 160 operate on separate copies of the same data. In some cases, the web browser 156 and the web page design editor 160 cooperate, and in other cases, the two modules operate independently of each other.

Within the floating window 174, the web page design editor 160 presents a digital graph paper image 176. The digital graph paper image 176 includes an array of grid blocks 178 that can be manipulated by the software professional.

The digital graph paper image 176 is configured to display one or more separately identifiable groups of one or more grid blocks each. Blocks that are grouped together are considered to be a “sector” 180 of grid blocks, and characteristics of both individual grid blocks 178, and sectors 180 of grid blocks 178 can be customized and maintained.

The set of grid blocks 178 in the digital graph paper image 176 is formed as an array having a length and a width. The array is configured to virtually align, by length and width, with the associated web page. As illustrated in FIG. 6, the digital graph paper image 176 can be virtually overlayed onto the web page 106.

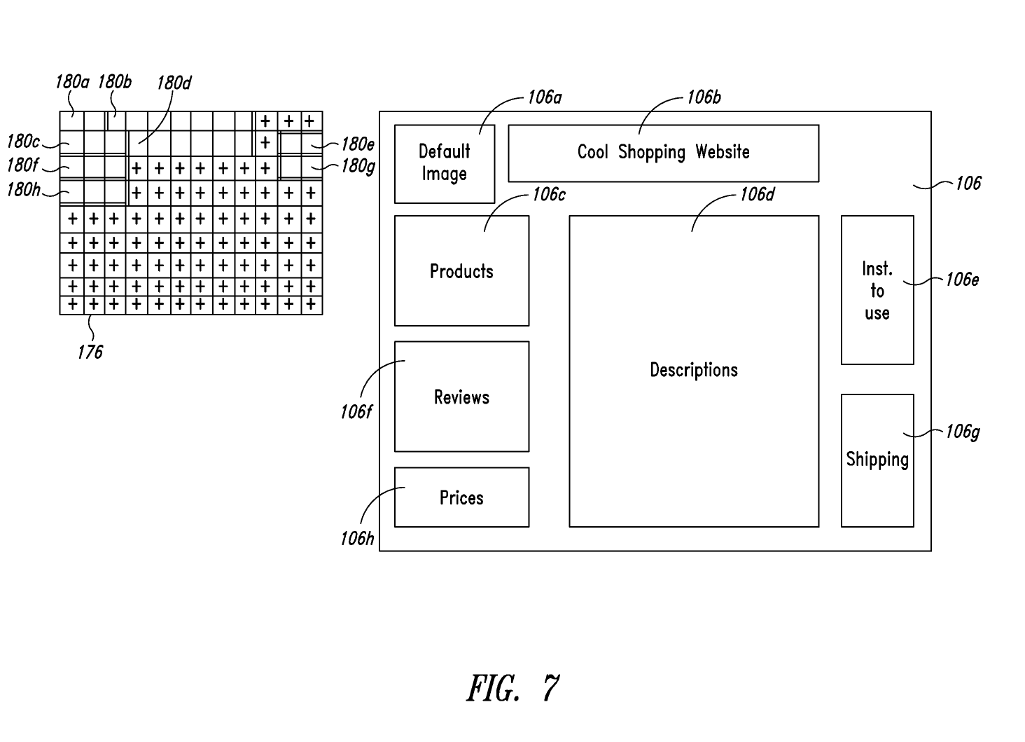

FIG. 7 illustrates a portion of the floating window 174 that contains a digital graph paper image 176, and an associated web page 106 is shown in a separate window. Sectors of the digital graph paper are illustrated in FIG. 7 with double or bold lines, but the sectors can be called out in other ways as well such as by color coding, patterning, bolding, and by any other mechanism.

The digital graph paper 180 of the web page design editor 160 in FIG. 7 is illustrated has having twelve (12) columns. Accordingly, each column in the embodiment has a width that represents 1/12^{th} of the width of the associated web page 106. By way of example, if the web page 106 is designed to be 960 pixels wide, each column in the digital graph paper image 176 of the web page design editor 160 will represent 80 pixels. As another example, if the associated web page is designed to be displayed in 1024 pixels, each column of the digital graph paper image will represent 85 pixels. As one more example, if the associated web page is designed to be displayed in 640 pixels, each column of the digital graph paper image will represent 53 pixels. The examples provided are rounded down to integers, and in this case, the remainder pixels are treated as padding, margins, gutter space, or another type of filler. In other cases, one or more columns may represent a different number of pixels than another column. Particularly, the web page design editor 160 may arrange the digital graph paper to variably have a wide range of configurations to be adaptable to web pages of many different sizes. In some cases, different web pages of a web site can have different preferred pixel widths, and the web page design editor 160 can automatically adapt the column widths for each page. In other cases, individual web pages can have different pixel widths, and the width of one or more columns can be configured by a software professional.

The digital graph paper 180 of the web page design editor 160 in FIG. 7 having twelve (12) columns is an exemplary embodiment. In other embodiments, a software professional can configure the number columns that will be arranged on the digital graph paper 160. For example, in some cases, instead of twelve (12) columns, a digital graph paper image 160 will be configured with 8 columns, 16 columns, or some other number. The number of columns can be hard-coded in the web page design editor 160, manually defined by a software professional, defined as a function of the associated website, or set in some other way. In FIG. 7, an association between sectors of the digital graph paper image 180 and sections of the web page 106 is illustrated. In FIG. 7, sector 180a is associated with web page section 106a, sector 180b is associated with web page section 106b, and so on. As illustrated in FIG. 7, sectors of one or more blocks are formed horizontally across one or more columns in the digital graph paper image 180. Each sector has a corresponding section on the web page 106. The section on the web page 106 horizontally spans the same number of virtual columns of the web page 106 as the sector spans on the digital graph paper image 180. Vertically, the grid blocks are illustrated on the digital graph paper image 180 as having a uniform height, but the vertical height of the sections on the web page 106 can span any distance to contain the content that is presented in the section.

A more detailed description of the grid blocks, sectors, and web page sections of FIG. 7 follows. In digital graph paper image 180, two grid blocks (i.e., two columns of the twelve total columns) are formed as sector 180a. On web page 106, a corresponding two/twelfths of the web page (i.e., 160 pixels of a 960 pixel wide web page) form section 106a. Section 106a is configured to contain a default image. The default image vertically spans the illustrated distance. In digital graph paper image 180, seven grid blocks (i.e., seven columns) are formed as sector 180b. On web page 106, a corresponding seven/twelfths of the web page (i.e., 560 pixels of a 960 pixel wide web page) form section 106b. Section 106b is configured to contain a header block for the web page (i.e., “Cool Shopping Website” in large letters). The header block of section 106b does not vertically span as far down the web page as the left most section 106a. The rightmost three columns of the first row of grid blocks in digital graph paper image 180 are not occupied in the embodiment.

Moving to a next (second) row of the digital graph paper image 180 in FIG. 7, a first three columns of grid blocks form sector 180c, a next six columns form sector 180d, an unused column, and a right-most two columns of grid blocks form sector 180e. Correspondingly, a Products sections 106c, a Descriptions section 106d, and an “Instructions to use” section 106e are respectively associated with the selected sectors. In a third row of digital graph paper image 180, a left-most three columns of grid blocks form sector 180f and a right-most two columns of grid blocks form sector 180g. In a fourth row, a left-most three columns of grid blocks form sector 180h. In the web page, the sectors of the third and fourth row are respectively associated with sections 106f, 106g, and 106h, which are configured for a Reviews section, a Shipping section, and a Prices section. On the web page 106, the vertical height of each section is manually or automatically adapted to the characteristics of the section's content or the parameters that define the section. Thus, a software professional can add as much content to a section as desired. The section on the web page will automatically grow vertically downward, but the horizontal boundary (e.g., the number of pixels defined for the section's width) will not be exceeded. As the software professional adds more and more content, the web page is automatically configured to get longer.

If the software professional determines that additional rows of sections on the web page are desired, then additional rows can be added to digital graph paper image 180. The rows can be added by a simple mouse click, a drag-and-drop operation, a manual number entry, or by some other mechanism.

When the software professional wants to form a new web page or modify an existing web page, the sectors on the digital graph paper image 180 can be manipulated, created, deleted, or modified. For example, the software professional can use a mouse to provide input to the web page design editor 160 that is arranged to select a sector of one or more grid blocks of the digital graph paper 180. In some cases, when the sector is selected on the digital graph paper 180, a corresponding section selection is indicated on the web page 106. For example, if sector 180a is selected on the digital graph paper 180, section 106a on the dynamically rendered web page 106 will be illuminated, flashed, emboldened, or given some other indicator.

After selecting or forming a sector, the software can provide additional input into the web page design editor 160 to modify a set of characteristics associated with the sector. For example, the sector (and thereby the corresponding section of the web page) can be provided with attributes to configure the sector for an image, a link, a text box. Further, additional input can modify or set colors, font, text or image sizes, and other attributes. The desirable image can be selected, text can be drafted, links can be made, and many other actions can be taken. In fact, as rows are added, new sectors and new content may be added. As sectors are selected, the underlying associated sections of the web page can be modified, and content can be added or modified.

The sectors of the digital graph paper 180 can be formed to represent both displayable and un-displayable objects that are included in the associated web page. For example, mouse-over regions can be formed as objects within sectors, links, and other un-displayed objects can be represented, and displayable objects such as images, text, and the like can also be represented.

As the characteristics of the sectors are created or modified, a build process and a deployment process are executed in real time. The build process can be carried out by the web page design editor 160 or the web development tool 158. The build process integrates the characteristics set for the sectors of the digital graph paper 180 into a web page environment to create a set of computer readable instructions that will, when executed, create the web page desired by the software professional. Within the web page design editor 160, the software professional is merely cutting, pasting, drafting text, filling in tables, and making selections from a range of preset parameters. Accordingly, the software professional is removed from the task of writing the software code (i.e., the computer readable instructions), and the build process will proceed without errors. Due to the visual editing environment of the web page design editor 160, entry level software professionals and other non-technical software professionals can also quickly and efficiently create and modify very powerful, complex websites.

In some cases, the tools will generate the software program instructions arranged to be executed by a web server and store them in memory. In other cases, the tools will copy one or more files that include the software program instructions arranged to be executed by a web server.

After the completion of the build process, the web page design editor 160 or the web development tool 158 will execute a deployment process in real time. The deployment process is configured to integrate generated (or copied) computer readable instructions that represent the software developer's modifications into the computer readable instruction set of the web page. Subsequently, the newly updated web page will be served in real time back to the software professional's browser. Due to the processes of the web page design editor 160 and the web development tool 158, the software professional is presented with real time changes to the web page as the web page is modified. The changes are not merely emulated, instead, the changes are made to a fully functional website. The software professional can navigate to other web pages, execute functions on the web pages, and take any action on the web site that is desired, and with the cooperative web page tools, changes, additions, and deletions can efficiently be performed by the software professional.

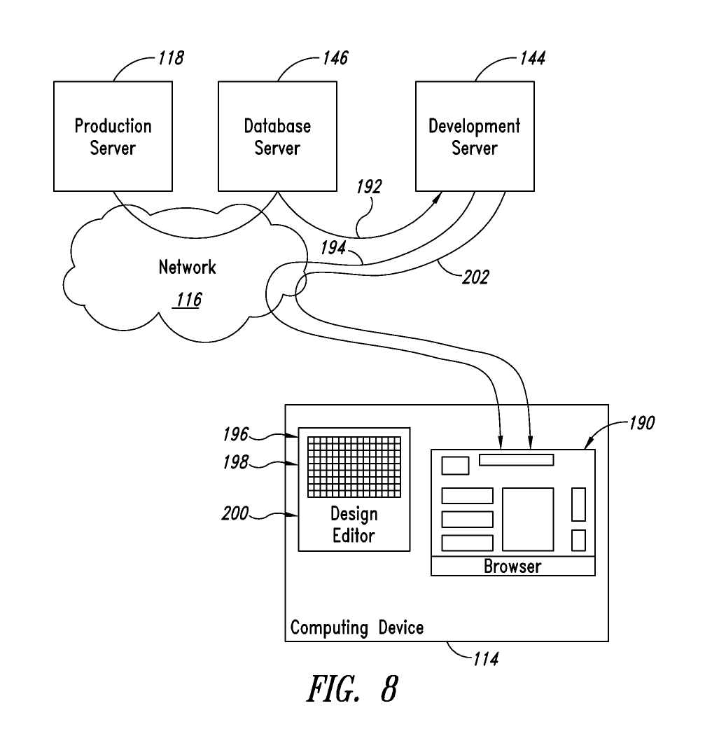

FIG. 8 is a block diagram illustrating a creation or modification process of a web page of a website. The modification process, build process, and deployment process are illustrated and described in Table 2.

TABLE 2
Creating or Modifying a Web Page

| | | |
|---|---|---|
| 190 | a. | Open a web browser; |
| | b. | Navigate to a web development website that is |
| | | executing a web development tool; |
| | c. | Direct the web development tool to open the |
| | | development website. |
| 192 | a. | Retrieve web pages of the website from a |
| | | production server and copy the web pages to a |
| | | development server; |
| | b. | Retrieve data from a database server as called |
| | | out by the copied web pages; |
| 194 | a. | Serve web pages of the website with a web |
| | | server by actively processing a set of computer |
| | | readable instructions of a web page being |
| | | served; |
| | b. | Accept user input into the web server to interact |
| | | with the web page being served |
| 196 | a. | Opening a design editor while continuing to |
| | | serve web pages of the website by executing a |
| | | design editor program in a window different from |
| | | a window of the web development tool; |
| | b. | Associate a web page of the website with a |
| | | digital graph paper image |
| 198 | a. | Present the digital graph paper image having |
| | | separately identifiable groups of grid blocks |
| | | wherein each of the separately identifiable |
| | | groups represents an object included in the |
| | | associated web page |
| 200 | a. | Accept user input into the design editor to select |
| | | a sector of one or more grid blocks of the digital |
| | | graph paper; |
| | b. | Accept user input into the design editor to |
| | | modify a set of characteristics associated with |
| | | the sector. |
| 202 | a. | Execute a build process in real time to generate |
| | | a set of computer readable instructions based |
| | | on the modified characteristics; |
| | b. | Execute a deployment process in real time to |
| | | integrate (e.g., overwrite) the set of computer |
| | | readable instructions into the associated web |
| | | page; |
| | c. | Serve the integrated set of computer readable |
| | | instructions (i.e., the updated web page) with |
| | | the web server in real time |

The web page design editor 160 may be integrated in the web development tool 158, or the web page design editor 160 may operate as an independent program. In some cases, the web page design editor 160 program is substantially written in a scripting language such as JAVASCRIPT.

The web page design editor 160 may operate by converting the desired operations directed by the user input into a markup language such as XML. As described herein, the web page design editor 160 may copy files or direct the web development tool 158 to copy files. The copied files may be converted to a markup language, compressed, and combined (e.g., ZIP file, TAR file, etc) into a small, easily transportable file or set of files. In this manner, particular “themes” or templates can be created and easily copied to develop new web pages. In some cases, theme templates are created and made available when the web development tool 158 is installed. In some cases, themes of a web page created by a software professional can be saved, exported, and later imported for use by another web page or even another web site. Thus, each page in a website can be created or modified with a different template. The theme templates may be stored in some embodiments in a library. The themes, and other data and program code for web pages or website functionality can be encrypted before storage in memory and decrypted so as to be executed by a server or browser module.

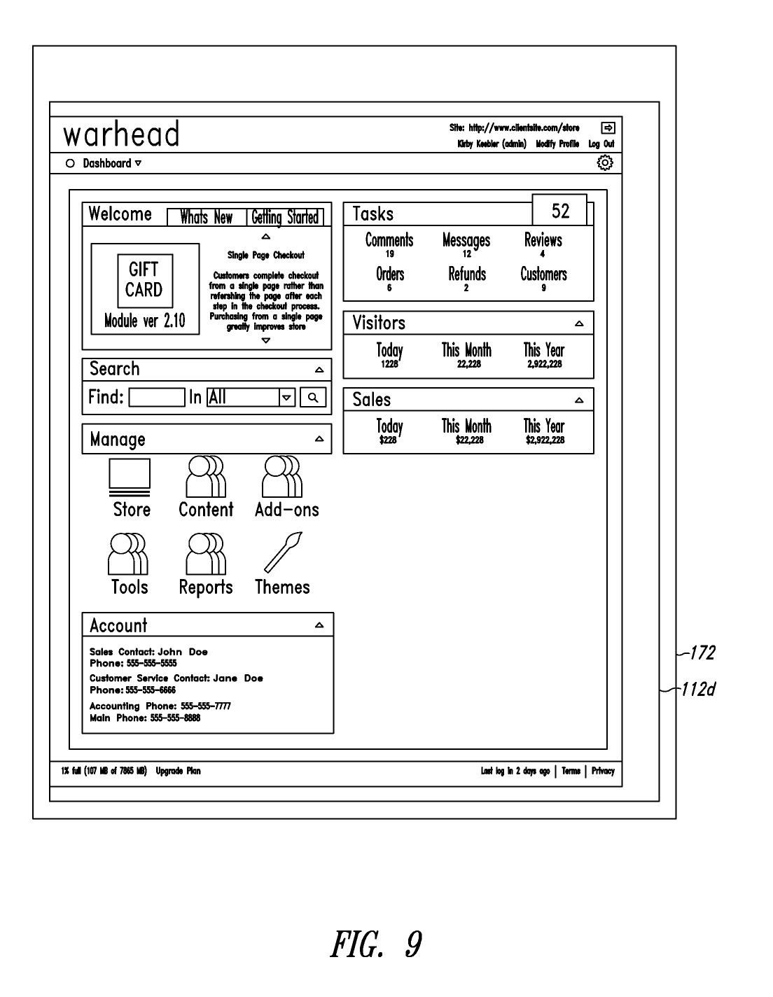

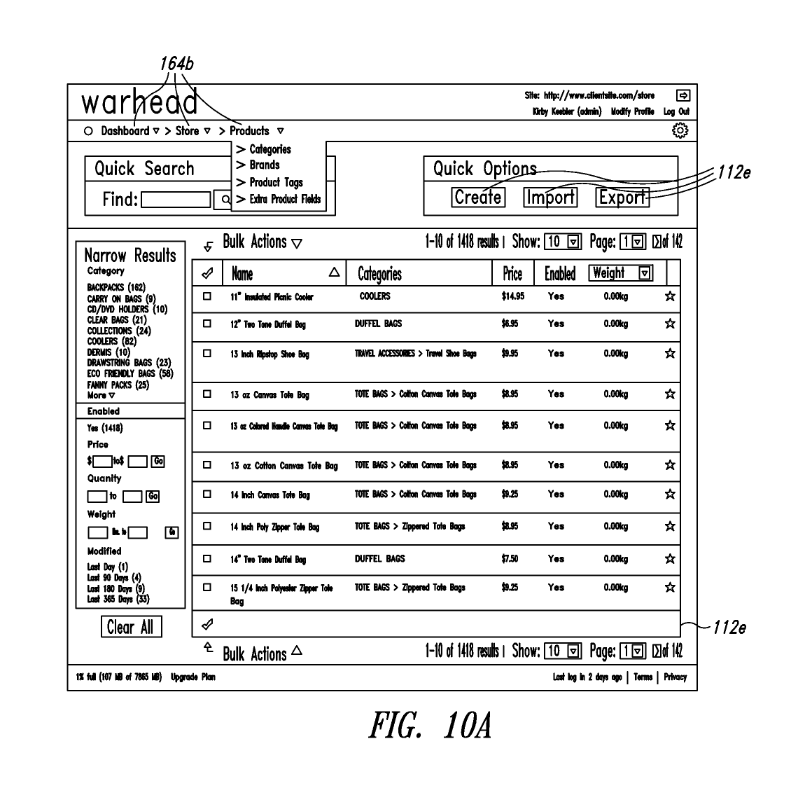

FIG. 9 illustrates yet another embodiment of a WDE interface 112d. In the embodiment, a dashboard view of a website is illustrated. The dashboard view is an interface to a website for a software professional. Through the dashboard, the software professional can perform many administrative and managerial functions for a website. Typically, each website that is manageable in an Internet website development environment 100 can be managed through a dashboard. The web development tool 158 module (FIG. 2) administers the dashboard.

In FIG. 9, the WDE interface 112d is visible within a browser window 172. The dashboard page in FIG. 9 allows the software professional to manage the store, manage the content of each webpage, manage particular add-ons of functionality in the website, and manage tools, reports, and themes included in the website. More or fewer than these optional features can also be presented. One of the options that can be selected, for example, is a “Store” option. Any of the other options shown on the dashboard of FIG. 9 or another dashboard could also have been chosen, but the “Store” option is chosen for the sake of simplicity.

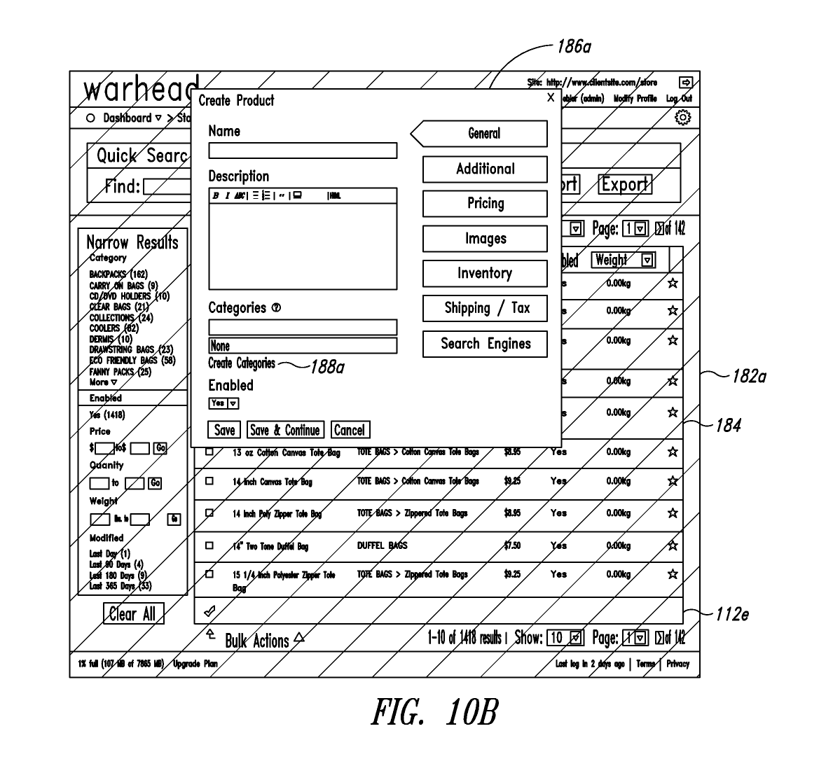

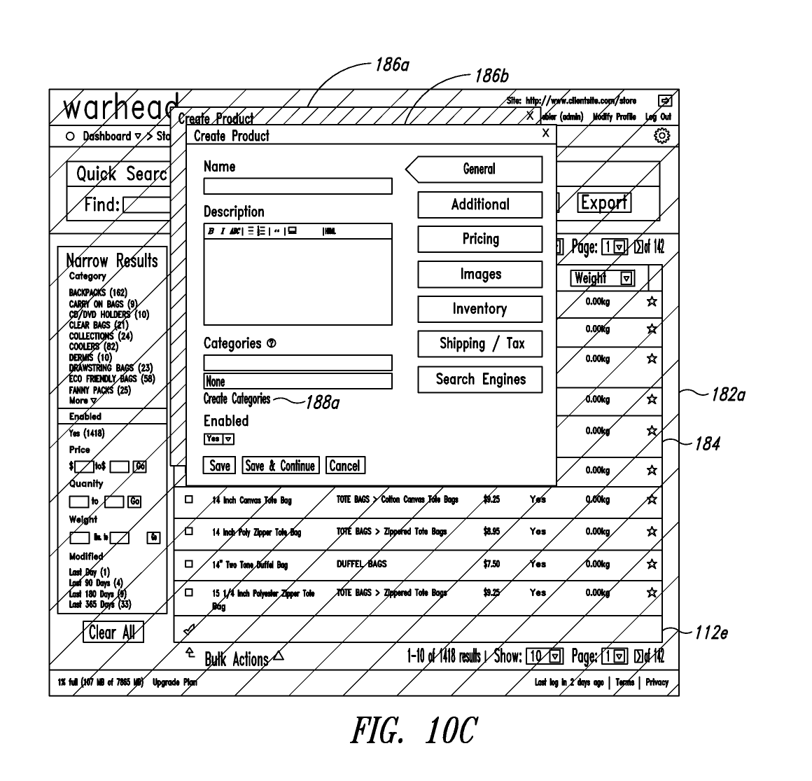

FIGS. 10a-c illustrate different aspects of a “Store” page of a website. Each of the pages in FIGS. 10a-c are shown as web pages served in a browser window such as browser window 172, but the browser or its associated window frame is not shown for simplicity. It is also understood that the page served within the browser is an embodiment of a WDE interface 112e.

Particular features of the webpage of FIG. 10a are pointed out. Horizontally presented breadcrumbs 164b are shown. Each breadcrumb operates as a hyperlink to navigate to different pages in the navigation list. When a page in the breadcrumb list includes options, the options are accessible with a drop-down list. In FIG. 10a, the “Products” breadcrumb is illustrated having a drop-down list, which is visible when a cursor hovers over the “Products” breadcrumb. In FIG. 10a, the breadcrumb drop-down list includes hyperlinks to a “Categories” page, a “Brands” page, a “Product Tags” page, and an “Extra Product Fields” page. Other descriptive text and pages could easily be illustrated and implemented. Quick action buttons 170b are also shown in FIG. 10a. In this case, the quick action buttons 170b link to particular forms; “Create,” “Import,” and “Export.” Other labels and actions could also be illustrated and implemented.

FIG. 10b illustrates an embodiment of the WDE interface 112e after the software professional has clicked the quick action “Create” button 170b. In this case, a first “Create Product” light box 186a is opened. When the first light box 186a is opened, the light box 186a is prominently illuminated on the screen in the browser window, and the area of the browser window 182a behind the light box 186a is shaded. In FIG. 10b, a shaded area 182a is illustrated. The shaded area in FIG. 10B covers the entire background that is no longer in focus, but in some embodiments, only the area generally behind the in-focus window is shaded while other areas, for example area 184, may be left un-shaded. In this way, windows are stacked such that a top window is in focus; the window just previously in focus is shaded with a first level of shading; a window even earlier in focus is shaded with a second, deeper level of shading, and so forth such that each progressive level deeper in the navigation results in earlier windows having a progressively deeper level of shading parallel. The depth or opacity of the shading may be pre-determined or a customizable feature. In some cases, the shading can be performed with different colors or in shades of gray. In the first light box 186a of FIG. 10b, a “Create Category” link 188a to a second light box is illustrated. The second light box can be opened in many ways; however, for simplicity in FIG. 10b, the second light box is opened with a hyperlink.

FIG. 10c illustrates yet another image of the embodiment of WDE interface 112e. In FIG. 10c, the software professional has followed the “Create Category” link 188a of FIG. 10b. A second light box 186b is opened. The second light box 186b is the “Create Category” light box, and this second light box 186b is cascaded above the first light box 186a.

In FIG. 10c, the area of the browser window behind the light boxes 186a, 186b is now shaded to a different depth 182b. In some embodiments, a first level of shading is represented by a first number “N.” A second level of shading is represented by a second number “M.” When an area of a web page has a first level of shading overlapped by a second level of shading, the second level of shading includes shading of both the first and second levels in sum (i.e., N+M). If a third level of shading is present, represented by a third number “O,” an area of the webpage having all three levels overlapped would be displayed with an even darker shading by the sum, N+M+O. In this example, the level of shading was performed by adding the representative shading level of each layer. In other embodiments, a different formula for creating the shading levels could be implemented. In the formula to create the cascaded light boxes of FIGS. 10a-c, wherein each lower layer light box is shaded, some embodiments permit each layer to have the same representative number for shading (e.g., N=M=O). By this feature, the shading level is “stackable,” and the level of shading indicates the depth (or number of layers) of a stack of light boxes.

It is understood that any number of light boxes may be cascaded. In different embodiments, any number of shading levels and any desirable formula to combine the shading levels can be implemented. For example, instead of a simple summation of shading levels, some embodiments include a “depth factor” in the formula. In such embodiments, a depth factor is assigned to each layer, and as each layer moves lower on the stack (i.e., because additional layers are added on top), the depth factor increases. The depth factor may be combined with the shading factor to reduce the amount of opacity that the lowest layers contribute to the stack.

As another example, each layer may be patterned with a set of parallel lines of a certain diameter. The lines of each layer will have a certain orientation. As each layer is added, the orientation of the parallel lines may be radially offset by some number of degrees from a relative axis. In this embodiment, the parallel lines of one layer will intersect with the lines of another layer thereby creating a darkening of the area below the overlapped layers. As more layers are added, each having parallel lines with a different radial offset from the reference axis, the area under the overlapping layers will darken.

Other features of the web development tool are available via the dashboard. For example, as a software professional creates or modifies a website, the web development tool 158 module will create the computer instructions to generate the web page. Based on the skill of the software professional, the webpage source code can be modified with other software tools.

Another feature of the web development tool that may be optionally enabled is a trace feature. If a trace feature is enabled, then each action taken by a user of the website is recorded. As the user makes changes through a WDE interface 112, hyperlinks that are taken are recorded, changes to data are recorded, and even individual keystrokes, mouse hovers (e.g., the length of time hovering over a particular area of the website) and their associated coordinates, and other input passed through the interface can be recorded. The feature can be used for security purposes, debug and other maintenance purposes, training purposes, and for other reasons.

Certain figures illustrates portions of a non-limiting embodiment of a computing device. The computing device includes operative hardware found in a conventional computing device apparatus such as one or more central processing units (CPU's), volatile and non-volatile memory, serial and parallel input/output (I/O) circuitry compliant with various standards and protocols, wired and/or wireless networking circuitry (e.g., a communications transceiver).

As known by one skilled in the art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to executed by a CPU.

The computing device further includes operative software found in a conventional computing device such as an operating system, software drivers to direct operations through the I/O circuitry, networking circuitry, and other peripheral component circuitry. In addition, the computing device includes operative application software such as network software for communicating with other computing devices, database software for building and maintaining databases, and task management software for distributing the communication and/or operational workload amongst various CPU's. In some cases, the computing device is a single hardware machine having the hardware and software listed herein, and in other cases, the computing device is a networked collection of hardware and software machines working together in a server farm to execute the functions of the Internet website development environment 100. Some aspects of the conventional hardware and software of the computing device is not shown in the figures for simplicity.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A website development method, comprising:
opening a website with a web development tool, the website having at least one web page, each web page of the website including a set of computer readable instructions, the set of computer readable instructions configured to create one or more displayable objects;
receiving served web pages of the website from a web server, the served web pages having been actively processed according to a first one or more instructions of the set of computer readable instructions of a web page being served;
communicating website user input to the web server, the website user input arranged to direct interactive execution of a second one or more instructions of the set of computer readable instructions of the web page being served; and
opening a design editor while continuing to receive served web pages of the website, the design editor configured to:
execute a deployment process in real time, the deployment process configured to integrate a second set of computer readable instructions into the set of computer readable instructions, wherein the set of computer readable instructions having the integrated second set of computer readable instructions is served by the web server in real time.

2. The method of claim 1 wherein the design editor is further configured to:
present a digital graph paper image, the digital graph paper image configured to display one or more separately identifiable groups of one or more grid blocks of the digital graph paper image, each of the one or more separately identifiable groups being representative of a displayable object included in a presently served web page of the website;
accept first design editor user input, the first design editor user input arranged to select a sector of one or more grid blocks of the digital graph paper;
accept second design editor user input, the second design editor user input arranged to modify a set of characteristics associated with the sector; and
execute a build process in real time, the build process configured to generate the second set of computer readable instructions.

3. The method of claim 1, further comprising:
automatically creating the website with the web development tool, the creating including generating an initial set of computer readable instructions configured to render a home page.

4. The method of claim 3 wherein automatically creating the website comprises:
copying one or more files from a first memory location to a second memory location.

5. The method of claim 3 wherein automatically creating the website comprises:
generating software program instructions arranged for execution by the web server, the instructions configured to produce the website when executed; and
storing the software program instructions in a memory.

6. The method of claim 1 wherein opening the website comprises:
copying one or more files from a first memory location associated with a production computing server to a second memory location associated with a development computing server.

7. The method of claim 1 wherein opening the website comprises:
opening a web browser;
navigating to a web development website, the web development website executing program instructions of the web development tool; and
directing the web development tool to open the website.

8. The method of claim 1 wherein served web pages of the website are retrieved from a production server, and wherein executing a deployment process in real time includes overwriting the set of computer readable instructions with the second set of computer readable instructions.

9. The method of claim 2 wherein opening the design editor comprises:
executing a design editor program; and
associating a first web page of the website with the digital graph paper image.

10. The method of claim 2 wherein the digital graph paper image includes a set of grid blocks, the set of grid blocks configured to virtually align, by length and width, with the associated first web page.

11. The method of claim 2 wherein the set of grid block are arranged in 12 columns, each column having a width in that represents a width of the associated first web page divided by 12.

12. The method of claim 2 wherein a number of columns of the digital graph paper is configurable.

13. The method of claim 2 wherein accepting second design editor user input arranged to modify a set of characteristics associated with the sector comprises:
adding at least one row of grid blocks, the added row of grid blocks representing additional content added to the associated first web page.

14. The method of claim 2 wherein accepting second design editor user input arranged to modify a set of characteristics associated with the sector comprises:
modifying at least one of a color, a font, or a text size.

15. At least one non-transitory computer readable storage medium whose stored contents configure a computing system to perform a method, the method comprising:
opening a web development tool website with a browser;
opening a managed website with the web development tool;
serving web pages of the managed website with a web server embedded in the web development tool;
accepting first user input into the web server, the first user input arranged to direct interactive execution of a web page design editor;
opening the web page design editor while continuing to serve web pages of the managed website;
associating a first web page of the managed website with the web page design editor;
presenting a digital graph paper image with the web page design editor, the digital graph paper image configured to display one or more separately identifiable groups of one or more grid blocks of the digital graph paper image, each of the one or more separately identifiable groups representing an object included in the associated first web page;
accepting second user input, the second user input arranged to select a sector of one or more grid blocks of the digital graph paper;
accepting third user input, the third user input arranged to modify the sector;
executing a build process in real time, the build process configured to update the first web page according to the third user input; and
executing a deployment process in real time, the deployment process configured to integrate the updated first web page with the managed website.

16. The at least one non-transitory computer readable storage medium according to claim 15 whose stored contents configure the computing system to perform the method wherein opening the managed website comprises:
copying one or more files from a first memory location associated with a production computing server to a second memory location associated with a development computing server, the production computing server arranged to serve web pages to public users via the Internet, the development server arranged to serve web pages only to users associated with the managed website.

17. The at least one non-transitory computer readable storage medium according to claim 15 whose stored contents configure the computing system to perform the method wherein opening the web page design editor comprises:
executing a design editor program, the design editor program operating in a window different from a window of the web development tool.

18. A development computing server, comprising:
a central processing unit (CPU); and
a memory, the memory having stored program instructions arranged to be executed by the CPU, the program instructions configured to:
open a web development tool website with a browser;
open a managed website with the web development tool;
serve web pages of the managed website with a web server embedded in the web development tool;
accept first user input into the web server, the first user input arranged to direct interactive execution of a web page design editor;
open the web page design editor while continuing to serve web pages of the managed website;
associate a first web page of the managed website with the web page design editor;
present a digital graph paper image with the web page design editor, the digital graph paper image configured to display one or more separately identifiable groups of one or more grid blocks of the digital graph paper image, each of the one or more separately identifiable groups representing a portion of the associated first web page;
accept second user input, the second user input arranged to select a sector of one or more grid blocks of the digital graph paper;
accept third user input, the third user input arranged to modify one or more characteristics associated with the sector;
execute a build process in real time, the build process configured to update the first web page according to the third user input;
execute a deployment process in real time, the deployment process configured to integrate the updated first web page with the managed website; and
accept fourth user input, the fourth user input arranged to interact with the modified one or more characteristics on the updated first web page, the updated first web page having been served by the web server.

19. The development computing server according to claim 18 wherein the program instructions are further configured to:
copy one or more files from a first memory location associated with a production computing server to a second memory location associated with the development computing server.

20. The development computing server according to claim 18 wherein the program instructions are further configured to:
present the digital graph paper image as a set of grid blocks, the set of grid blocks configured to virtually align, by length and width, with the associated first web page, the set of grid block arranged in 12 columns, each column having a width in that represents a width of the associated first web page divided by 12, wherein the third user input is arranged to modify the one or more characteristics associated with the sector by adding at least one row of grid blocks, the added row of grid blocks representing additional content added to the associated first web page.
